(19) United States
(12) Patent Application Publication
(10) Pub. No.: US 2013/0296482 A1
(43) Pub. Date: Nov. 7, 2013

(54) METHOD OF PRODUCING A RUBBER MIX WITH LARGE-AREA REINFORCING FILLERS

(71) Applicants: Salvatore Cotugno, Roma (IT); Enrico Carone, Ladispoli (IT)

(72) Inventors: Salvatore Cotugno, Roma (IT); Enrico Carone, Ladispoli (IT)

(73) Assignee: BRIDGESTONE CORPORATION, Chuo-Ku, Tokyo (JP)

(21) Appl. No.: 13/988,639

(22) PCT Filed: Dec. 1, 2011
(86) PCT No.: PCT/IB2011/055418

§ 371 Date: Jul. 16, 2013

(30) Foreign Application Priority Data
Dec. 1, 2010 (IT) TO2010A000959

(51) Int. Cl. C08J 3/20

(52) U.S. Cl. CPC C08J 3/203
USPC 524/575.5

(57) ABSTRACT

A method of producing rubber mixes, including a step of mixing a reinforcing filler, having a surface area of over 220 m²/g and a particle size of less than 0.1 μm, with a cross-linkable, unsaturated-chain polymer base. The mixing step is performed in the aqueous phase, in the presence of a surface-active agent of molecular formula (I) (R₁CONR₂CHR₃COO⁻)nXⁿ⁺ (I) where: R₁ is an aliphatic group C₄-C₂₀ R₂ is H or an aliphatic group C₁-C₈ R₃ is H or an aliphatic or aromatic group C₁-C₈ X is a metal cation n is an integer of 1 to 3.

### TECHNICAL FIELD

The present invention relates to a method of producing a rubber mix with large-area reinforcing fillers. More specifically, the present invention relates to the production of a mix comprising large-area silica, to which the following description refers purely by way of example.

### BACKGROUND ART

As is known, many rubber mixes are produced using reinforcing fillers, such as carbon black or silica, to obtain a finished product with specific mechanical characteristics.

To do this, it is essential that the reinforcing filler be dispersed evenly in the polymer base, and, therefore, that mixing be performed as efficiently as possible.

Mixing is normally performed in mechanical Banbury mixers.

It has long been known that the physical characteristics of reinforcing fillers, such as area and particle size, may seriously affect the mechanical properties of the mix. For example, in the tyre industry, large-area and/or fine particle size silica is known to improve the mix in terms of wear and rolling resistance.

Another important point to note is that a reinforcing filler capable of producing a mix of superior mechanical properties may also be used in smaller amounts, thus reducing the specific weight of the mix as a whole.

At present, large-area and/or fine particle size silica is difficult to use on an industrial scale, for reasons of workability of the mix. That is, the larger the area and the finer the particle size of the silica are, the more viscous the mix is to work, with the result that mixing takes longer and the mixer has to work harder, with obvious drawbacks in terms of output and power consumption.

In short, silica with a larger area and finer particle size improves the mechanical properties of the cured mix, but also greatly increases the viscosity of the green mix. More specifically, silica with an area of over 220 m²/g may render the mix completely unworkable, if mixed the conventional way in a Banbury mixer (closed-chamber mixing) and/or in mills (open-chamber mixing). Also, mixing problems often result in poor dispersion of the silica in the elastomer matrix, thus resulting in poor properties and wear resistance.

As will be clear to anyone skilled in the art, the difficulty encountered in using silica, which otherwise could have major advantages in terms of performance of the finished mix, is a serious limitation in the manufacture of numerous rubber products.

### DISCLOSURE OF INVENTION

It is an object of the present invention to provide a method of producing rubber mixes, that can employ large-area and/or fine particle size reinforcing fillers, without incurring the drawbacks of the known art.

According to the present invention, there is provided a method of producing rubber mixes, comprising a step of mixing a reinforcing filler with a cross-linkable, unsaturated-chain polymer base; said method being characterized in that said mixing step is performed in the aqueous phase, and said reinforcing filler has a surface area of over 220 m²/g, and a particle size of less than 0.1 μm.

### BEST MODE FOR CARRYING OUT THE INVENTION

In a preferred embodiment, said mixing step comprises adding an aqueous suspension of reinforcing filler to a latex of the cross-linkable, unsaturated-chain polymer base.

In a preferred embodiment, the reinforcing filler is silica.

In a preferred embodiment, the aqueous phase comprises curing agents, and a surface-active agent of molecular formula (I)

(R₁CONR₂CHR₃COO⁻)nXⁿ⁺ (I)

where:

R₁ is an aliphatic group C₄-C₂₀

R₂ is H or an aliphatic group C₁-C₈

R₃ is H or an aliphatic or aromatic group C₁-C₈

X is a metal cation, preferably an alkaline cation, and

n is an integer of 1 to 3.

Preferably, the aliphatic group R₁ comprises a double bond.

Preferably, the surface-active agent of molecular formula (I) is the compound CH₃(CH₂)₇CHCH(CH₂)₇CONHCH₂COO⁻X⁺ or the compound CH₂CH(CH₂)₈CONHCH₂COO⁻X⁺.

Preferably, the alkaline cation X⁺ is Na⁺.

The following are non-limiting examples for a clearer understanding of the invention.

### EXAMPLES

Four mixes A₁-A₄ with the compositions in phr shown in Table I were produced according to the invention; and a control mix A_{ctrl} with the composition in phr shown in Table I was produced using the traditional mechanical Banbury mixer method. The control mix differed from those of the invention solely as regards the type of silica used and the absence of a surface-active agent. If the control mix were to be produced using the same silica as in the invention mixes, the area and particle size of the silica would result in such a high viscosity of the control mix as to make it difficult to mix.

TABLE I

| | A₁ | A₂ | A₃ | A₄ | A_{ctrl} |
|---|---|---|---|---|---|
| NR (latex) | 100 | 100 | 100 | 100 | 100 |
| Silica* dispersed | 80 | 80 | 80 | 80 | — |
| in water | | | | | |
| Silica** | — | — | — | — | 80 |
| Silane | 0 | 3 | 6 | 10 | 15 |
| Sulphur | 2 | 2 | 2 | 2 | 2 |
| Zn oxide | 3 | 3 | 3 | 3 | 3 |
| MBTS | 2 | 2 | 2 | 2 | 2 |
| Surface-active | 0.5 | 0.5 | 0.5 | — | — |
| agent (a) | | | | | |
| Surface-active | — | — | — | 0.5 | — |
| agent (b) | | | | | |

In Table I, the quantity of silica* refers to the dry silica in the aqueous dispersion, and the silica* used has an area of 330 m²/g, and a particle size of 7 nm.

The silica** used has an area of 200 m²/g, and a particle size of 0.2 μm.

In the invention mixes (A₁-A₄), silane was added to the completely dry mix, i.e. after the in-water mixing stage, and more specifically in an open mill.

Surface-active agent (a) was the compound CH₃(CH₂)₇CHCH(CH₂)₇CONHCH₂COO⁻Na⁺; and surface-active agent (b) the compound CH₂CH(CH₂)₈CONHCH₂COO⁻Na⁺.

Unlike the control mix produced using the conventional method, the invention mixes were produced as follows:

mixing step: all the ingredients were dispersed simultaneously in water; and the resulting aqueous solution was first agitated mechanically, and then sonicated to form an aqueous emulsion. As shown in Table I, natural rubber was added in the form of latex, and silica in the form of an aqueous dispersion.

settling step: the aqueous emulsion was allowed to settle for 60 minutes, until a clearly distinguishable rubber mix in water was formed;

separation step: the rubber mix was separated by filtering, possibly followed by drying.

The settling step is preferable, but not essential if appropriate concentrations of surface-active agents are employed.

The mixing step may differ from the one described above. That is, a number of emulsions, each comprising one ingredient of the mix and an appropriate quantity of surface-active agent, may be produced, and subsequently combined into one emulsion, which is then mixed to form the rubber mix in water.

Laboratory Testing

The resulting mixes were subjected to rheometric testing as per ASTM Standard D5289 at a temperature of 160° C., and to dynamic physical testing as per ASTM Standard D5279 at 25° C. temperature and 50 Hz frequency.

The test results are shown in Table II. The MH and ML values are expressed in dN*m; T′10, T′50 and T′90 in minutes; and physical properties in MPa.

Table II also shows the dispersion index values. The dispersion index is the ratio 100×ΔE′/E′_{0.1%strain}, where ΔE′ equals E′_{0.1%strain}−E′_{4.0%strain}. The lower the dispersion index is, the better the silica is dispersed in the polymer matrix.

TABLE II

| | A₁ | A₂ | A₃ | A₄ | A_{ctrl} |
|---|---|---|---|---|---|
| ML | 12.7 | 10.1 | 8.7 | 7.3 | 9.3 |
| MH | 29.0 | 24.1 | 23.0 | 21.8 | 35.9 |
| T′ 50 | 0.5 | 0.7 | 1.0 | 1.4 | 3.4 |
| T′ 90 | 1.1 | 1.4 | 2.1 | 5.1 | 16.7 |
| Dispersion index | 38 | 35 | 30 | 28 | 100 |

Alternatively, the method according to the invention may comprise only mixing the reinforcing filler and polymer base in the aqueous phase, followed by mechanical mixing in a Banbury mixer, in which the other mix ingredients are added to the polymer/silica base mix produced at the in-water mixing stage. More specifically, the polymer/silica base mix produced at the in-water mixing stage is separated from the liquid phase and dried, and is then reloaded into the Banbury mixer, where the other ingredients are added to produce the finished mix.

The method according to the invention has the major advantage of enabling use of reinforcing fillers capable of greatly improving the mechanical properties of the mix, and/or enabling a reduction in the amount of reinforcing filler in the mix, thus reducing the specific weight of the mix. In fact, mixing in water poses no viscosity problems.

The method according to the invention also provides for better dispersing the reinforcing fillers in the polymer base.

Lastly, the method according to the invention provides for considerable energy saving by employing no, or only marginally employing, electrically powered mixing devices.

1-11. (canceled)

12. A method of producing rubber mixes, comprising a step of mixing a reinforcing filler with a cross-linkable, unsaturated-chain polymer base; said method being characterized in that said mixing step is performed in the aqueous phase, and said reinforcing filler has a surface area of over 220 m²/g, and a particle size of less than 0.1 μm; said aqueous phase comprising curing agents and a surface-active agent of molecular formula (I)
(R₁CONR₂CHR₃COO⁻)n Xⁿ⁺
where:
R₁ is an aliphatic group C₄-C₂₀
R₂ is H or an aliphatic group C₁-C₈
R₃ is H or an aliphatic or aromatic group C₁-C₈
X is a metal cation
n is an integer of 1 to 3.

13. A method of producing rubber mixes, as claimed in claim 12, characterized in that said mixing step comprises adding an aqueous suspension of reinforcing filler to a latex of the cross-linkable, unsaturated-chain polymer base.

14. A method of producing rubber mixes, as claimed in claim 12, characterized in that the reinforcing filler is silica.

15. A method of producing rubber mixes, as claimed in claim 12, characterized in that the aliphatic group R₁ comprises a double bond.

16. A method of producing rubber mixes, as claimed in claim 15, characterized in that the surface-active agent of molecular formula (I) is the compound CH₃(CH₂)₇CHCH(CH₂)₇CONHCH₂COO⁻X⁺ or the compound CH₂CH(CH₂)₈CONHCH₂COO⁻X⁺.

17. A method of producing rubber mixes, as claimed in claim 12, characterized in that the metal cation X⁺ is Na⁺.

18. A rubber mix comprising a large-area reinforcing filler, characterized by being produced using the method as claimed in claim 12.

19. A rubber mix as claimed in claim 18, characterized in that said reinforcing filler is silica.

20. A rubber mix as claimed in claim 19, characterized in that the silica has a surface area of over 220 m²/g and a particle size of less than 0.1 μm.

21. A tyre, characterized by comprising at least one portion made from the mix as claimed in claim 18.
